(19) United States
(12) Patent Application Publication
(10) Pub. No.: US 2012/0102949 A1
(43) Pub. Date: May 3, 2012

(54) APPARATUS FOR THE UTILISATION OF THERMAL RADIATION

(76) Inventor: David Hugo Boyle, Lytham St. Annes (GB)

(21) Appl. No.: 13/203,583

(22) PCT Filed: Feb. 26, 2010
(86) PCT No.: PCT/GB2010/050344

§ 371 Date: Jan. 16, 2012

(30) Foreign Application Priority Data
Feb. 26, 2009 (GB) 0903287.1

(51) Int. Cl. F03G 6/00; C02F 1/04; F03G 7/06

(52) U.S. Cl. 60/641.8; 60/527; 203/10

(57) ABSTRACT

Apparatus for the utilisation of thermal radiation having a thermosensitive member, a Fresnel lens for selectively directing thermal radiation onto the thermosensitive member, and a generator means for converting the resulting expansion and contraction of the thermosensitive member into electrical power. The thermosensitive member may be a hollow elongate rod through which fluid may be channelled. The fluid may be salt water and the thermal radiation may be used to transform the water into steam to thereby desalinate the water.

### CROSS REFERENCE TO RELATED APPLICATIONS

This application is a 35 U.S.C. §371 national stage entry utility patent application of, and claims priority to, PCT/GB2010/050344, filed on Feb. 26, 2010, and also claims priority to Great Britain Application No. GB0903287.1, filed on Feb. 26, 2009, the entireties of which are incorporated herein by reference.

### FIELD OF THE INVENTION

This invention relates to apparatus for the utilisation of thermal radiation to heat and expand a thermosensitive material and to use that expansion to produce electrical power.

### BACKGROUND OF THE INVENTION

The use of thermal radiation from the sun, referred to hereinafter as solar radiation, to heat thermosensitive material and produce electrical power from its subsequent expansion and contraction is known. WO91/09227 (Boyle) in particular discloses an arrangement that focuses solar radiation onto a metal rod in order to heat the rod and cause it to expand. Expansion and subsequent contraction of the rod is used to drive a hydraulic cylinder which in turn operates a generator to produce electrical power.

This arrangement requires heavy and expensive focussing means and, additionally, is incapable of inducing expansion and contraction of the thermosensitive member with a high enough frequency to produce consistent electrical output.

This invention seeks to provide an improved and more efficient device for producing electrical power derived from the sun.

### SUMMARY OF THE INVENTION

According to a first aspect of the present invention, there is provided apparatus for the utilisation of thermal radiation, the apparatus comprising a thermosensitive member, a Fresnel lens for selectively directing thermal radiation onto the thermosensitive member, and a generator means for converting the resulting expansion and contraction of the thermosensitive member into electrical power.

Advantageously, Fresnel lenses are less bulky, heavy and expensive than conventional convex lenses. It is therefore possible to make Fresnel lenses with a larger surface area than conventional lenses and thus focus more thermal radiation onto the thermosensitive member. This apparatus is therefore capable of producing a greater temperature change of the rod which results in increased linear expansion of the rod and, consequently, more electrical power.

In a preferred embodiment, the thermosensitive member is generally elongate. Preferably the thermosensitive member is a rod. Preferably the thermosensitive member is mounted to a frame. Preferably, one end of the thermosensitive member is fixed at one side of the frame and is free at the opposite side of the frame. Preferably, the free end of the thermosensitive member extends through the frame. More preferably, the free end of the thermosensitive member is connected to a piston. More preferably, the piston is seated within a hydraulic cylinder which is connected to a hydraulic motor. Preferably the piston moves from a first position in which the thermosensitive member is in its normal, ambient temperature state, to a second position in which the thermosensitive member is in an expanded state, said second position corresponding to the piston's maximum stroke limit.

In a preferred embodiment, the free end of the thermosensitive member is connected to a piston via a corresponding connecting rod. Preferably said connecting rod is pivotally mounted at either end to the free end of the thermosensitive member and the piston respectively. Preferably, the connecting rod pivots about an associated fulcrum which is positioned at a distance adjacent to the rod. More preferably there is provided a plurality of pistons and associated connecting rods.

In a preferred embodiment, the Fresnel lens is arranged adjacent to the thermosensitive member. Preferably, the Fresnel lens can move in an arc about the thermosensitive member. More preferably, the lens can track the sun throughout the day so that maximum thermal radiation from the sun is focussed onto the rod.

In a preferred embodiment, the thermosensitive member has a hollow core. Preferably, fluid can be channelled through the hollow core. More preferably, the thermosensitive member is sealed at either end by removable pressure covers.

In a preferred embodiment, the thermosensitive member comprises a plurality of hollow cores. Preferably the hollow cores are spaced from one another through the thermosensitive member.

According to a second aspect of the present invention, there is provided a method of producing electrical power comprising the steps of:

arranging a Fresnel lens relative to a thermosensitive member;

using the Fresnel lens to direct solar radiation onto said thermosensitive member to cause expansion thereof; and

using the expansion of said thermosensitive member to drive a generator means for the generation of electrical power.

In a preferred embodiment, the method comprises the additional step of using the contraction of the thermosensitive member to drive the generator. Thus both the expansion and contraction of the thermosensitive member can be used to drive the generator.

According to a third aspect of the present invention, there is provided a method of desalinating salt water comprising the steps of:

arranging a Fresnel lens relative to a hollow thermosensitive member;

using the Fresnel lens to direct solar radiation onto said hollow thermosensitive member to cause said thermosensitive member to heat up;

injecting water into said hollow thermosensitive member;

directing the resulting water vapour out of said thermosensitive member; and

cooling and condensing said water vapour.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the claims. To assist those of ordinary skill in the relevant art in making and using the subject matter hereof, the specific embodiments of the present invention will now be described with reference to the accompanying drawings:

FIG. 1 shows a perspective view of part of the assembled apparatus in accordance with the first embodiment of the present invention;

FIG. 2 shows an end view of the Fresnel lens and mounting frame as shown in FIG. 1;

FIG. 3 shows a side view of a piston arrangement and hydraulic motor to be used in combination with the apparatus shown in FIG. 1;

FIGS. 4 (a) and (b) show an overhead view and a side view of a second embodiment of the present invention;

FIGS. 5 (a) to (c) show an overhead view, an end view and a side view of a support section shown in FIGS. 4 (a) and (b);

FIGS. 6 (a) to (c) show an overhead view, a side view and an end view of the Fresnel lens and mounting frame for use with the apparatus shown in FIGS. 4 (a) and (b);

FIGS. 7 (a) to (c) show a front end view, a side view and a rear end view of a driving unit and piston arrangement for use in place of the piston arrangement shown in FIGS. 4 (a) and (b);

FIG. 8 shows a third embodiment of the present invention;

FIGS. 9 (a) and (b) show an end view of two alternative rods for use in the apparatus shown in FIG. 8; and

FIGS. 10 (a) and (b) show two sections of a schematic of a power station which uses apparatus according to the present invention.

### DETAILED DESCRIPTION OF THE EMBODIMENTS OF THE INVENTION

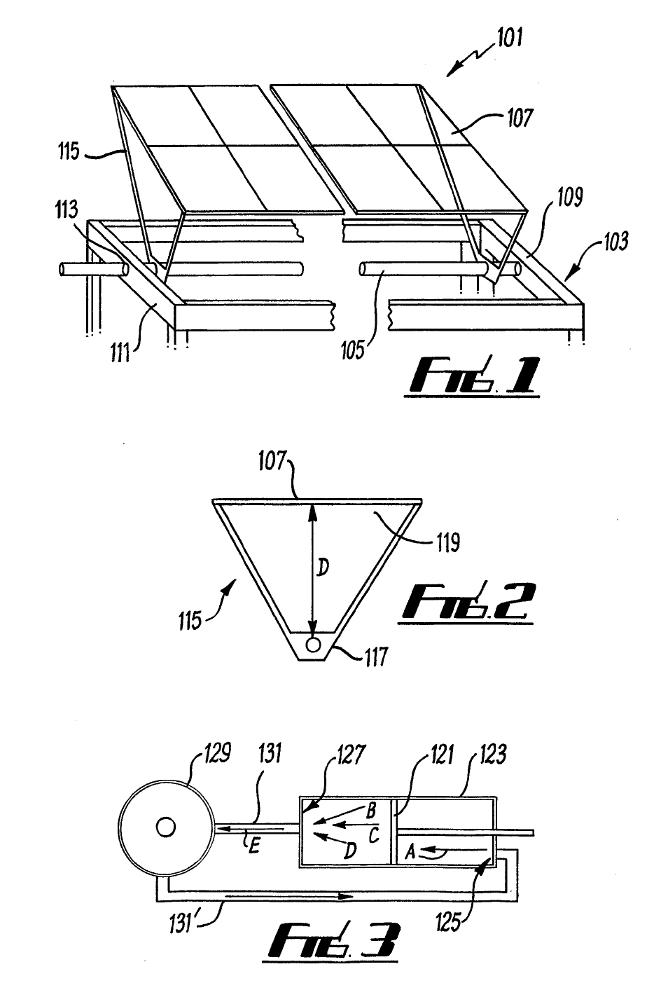

Referring now to FIG. 1, there is shown part of an apparatus for converting solar radiation into electrical power. The apparatus 101 comprises a frame 103, a rod 105 which is mounted within the frame, a Fresnel lens 107 which is adjacent to the rod and a generator means (not shown).

The rod is generally elongate and has the property of expanding when subjected to heat. Preferably, the material should have a high linear thermal expansion coefficient relative to other solid thermosensitive materials. A suitable material for the rod is stainless steel which has a linear thermal expansion coefficient of 17.3×10⁻⁶ K⁻¹.

The rod is supported in a substantially horizontal plane by the frame, a suitable material for which is steel. The steel frame is rectangular in shape and has four supporting legs which are firmly secured to the ground to provide a solid base for the rod. The metal rod is secured at one end to a sidewall 109 of the frame and extends through the opposing sidewall 111 of the frame via an appropriately sized aperture 113. Heat insulating material (not shown) is placed between the rod and the supporting portions of the frame to minimise the loss of thermal energy from the rod to the frame.

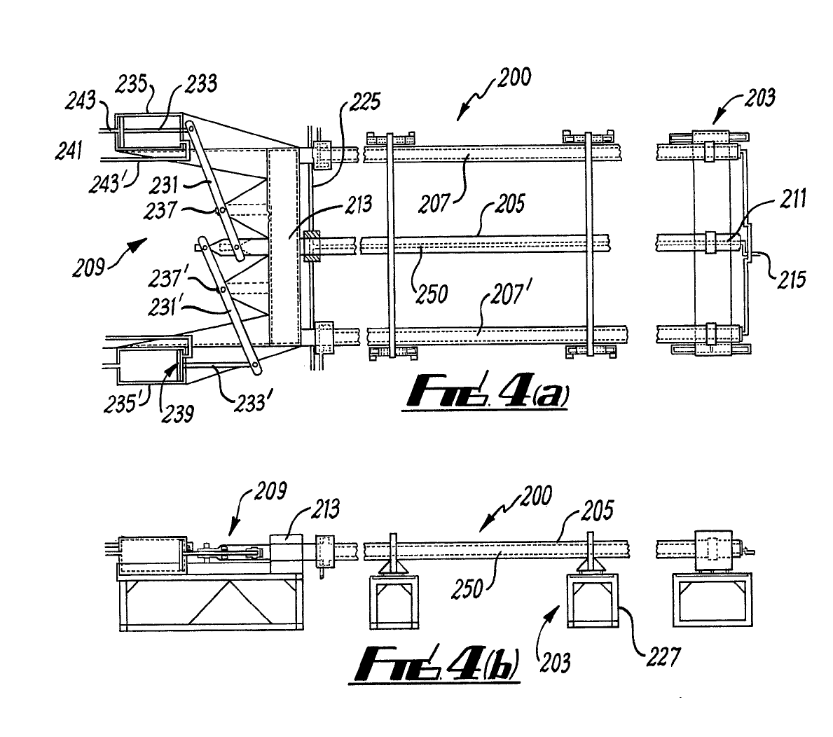

A Fresnel lens 107, which serves to focus solar radiation onto the rod, is mounted to the rod via a triangular frame 115 which is attached at intervals along the length of the lens. Referring to FIG. 2, the corner 117 of each triangular frame that opposes the side 119 supporting the Fresnel lens 107 is apertured to allow the rod to be inserted through the triangular frame. In this way, the Fresnel lens is mounted at a distance D from the metal rod and is capable of pivoting about the longitudinal axis of the rod through rotation of the triangular frame about the rod. This permits the Fresnel lens to track the sun across the sky and allows the Fresnel lens to be used with maximum efficiency throughout the day. The dimensions of the frame are such that, when mounted to the rod, the focal line of the Fresnel lens is on the rod.

A cover is provided (not shown) which can be utilised, optionally, to automatically shade the rod from the solar radiation. This allows the rod to be selectively heated and cooled depending on whether it is desired to have the rod in an expanded or contracted state.

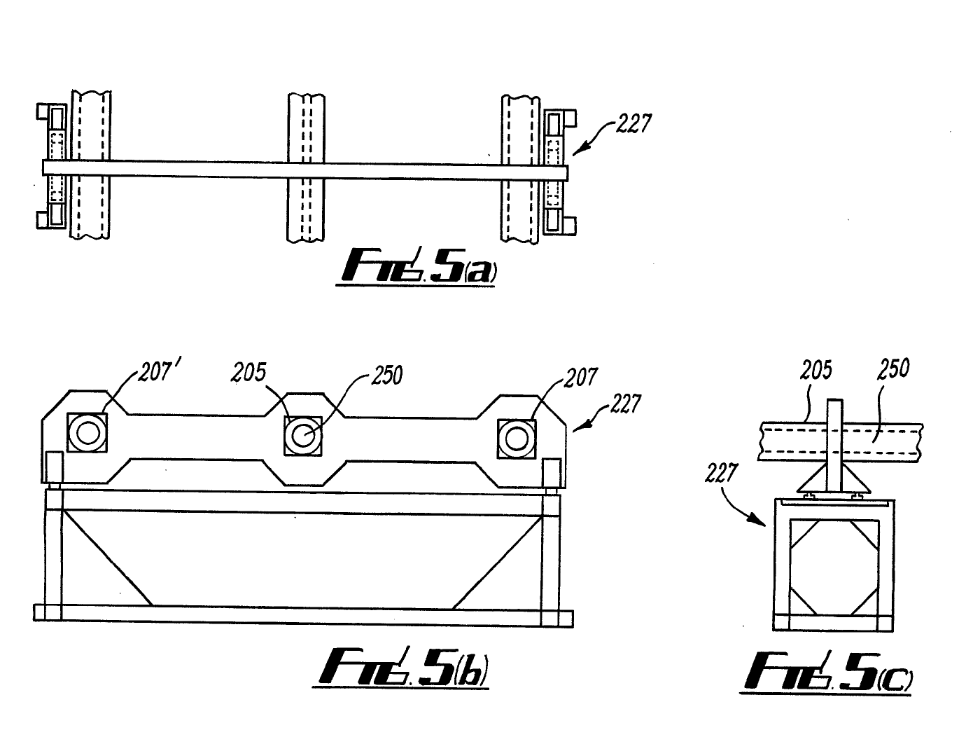

Referring to FIG. 3, one end of the metal rod (not shown) is operatively connected to a piston 121 which is seated within a hydraulic cylinder 123 and is movable from a first position 125, in which the rod is in its normal room temperature state, to a second position 127 in which the rod is in an expanded state. The piston is used to drive a hydraulic motor 129 which is attached to a generator (not shown) for the production of electrical power. The piston and hydraulic cylinder are connected to the hydraulic motor via two fluid lines 131 and 131′ which allow fluid to be forced through the hydraulic motor regardless of which way the piston moves.

In use, during daylight hours, solar radiation is focussed onto the metal rod by the Fresnel lens resulting in increased temperature of the rod which causes it to expand. Since the rod is fixed at one end, the resulting linear expansion of the rod occurs at the free end which forces the piston to move from the first position to the second position. Movement of the piston within the hydraulic cylinder (Denoted by arrow A) pressurises the fluid contained therein and forces the hydraulic fluid through the hydraulic motor via the fluid lines as depicted by arrows B, C, D and E. The motor drives the generator which generates electrical power.

Having heated the rod sufficiently to force the piston to its second position, the cover (not shown) is used to shade the rod from the thermal radiation. This facilitates the cooling and contraction of the rod which forces the piston to move back to its first position. The movement of the piston from the second position to the first position forces the hydraulic fluid in the reverse direction through the fluid lines which in turn drives the motor. In order to utilise this reversed fluid movement, the polarity of the motor is reversed to drive the generator and generate electrical power.

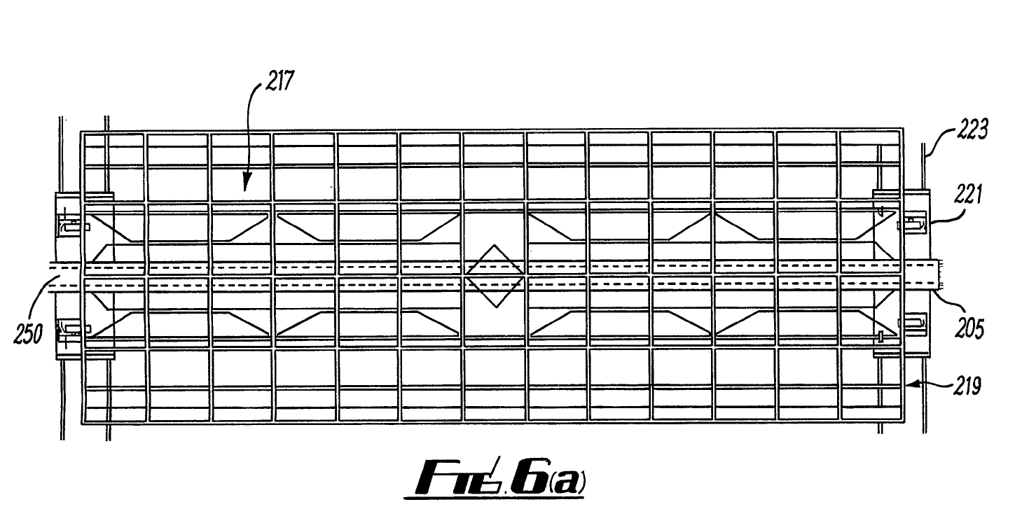

In an alternative embodiment, referring to FIGS. 4 (a) and (b), there is provided apparatus 200 comprising a frame 203, a central rod 205 which is mounted to the frame, two further rods 207 and 207′ which are mounted to the frame, a piston arrangement 209 and a generator means (not shown).

The main central rod is comprised of stainless steel and is supported by the frame in a substantially horizontal plane. The rod is fixed at one end 211 of the frame and threaded through an appropriately sized aperture at the opposing side 213 of the frame. Thus when the rod undergoes linear expansion, this occurs at the free end. The central rod has a hollow core 250, access to which is permitted by a pipeline 215 which is connected to a water supply (for reasons which will be explained hereinafter).

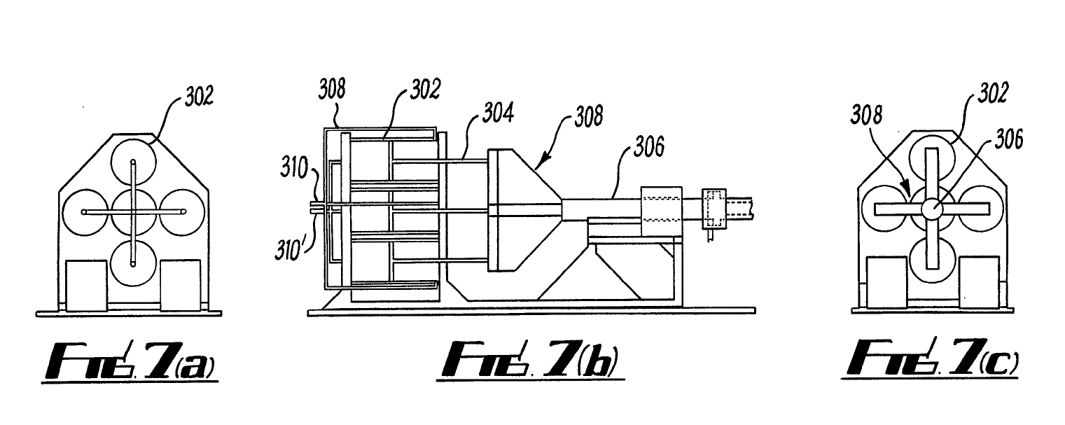

Referring to FIGS. 6 (a) to (c), a Fresnel lens 217 is mounted to the central rod 205 using a triangular frame 219. The Fresnel lens is mounted such that its focal line is on the central rod. The mounting frame 219 is capable of being moved, and operates to be moved, vertically from the rod by a hydraulic lifting mechanism 221 and perpendicularly from the rod along rails 223.

Referring again to FIGS. 4 (a) and (b), the two additional hollow metallic rods, 207 and 207′, are disposed on each side of, and parallel to, the central rod 205. The two rods are also mounted to the frame but may be fixed at either end so that they cannot undergo linear expansion. The two rods are connected to the central rod by pipelines 225 which have valves (not shown) to optionally permit fluid communication therebetween.

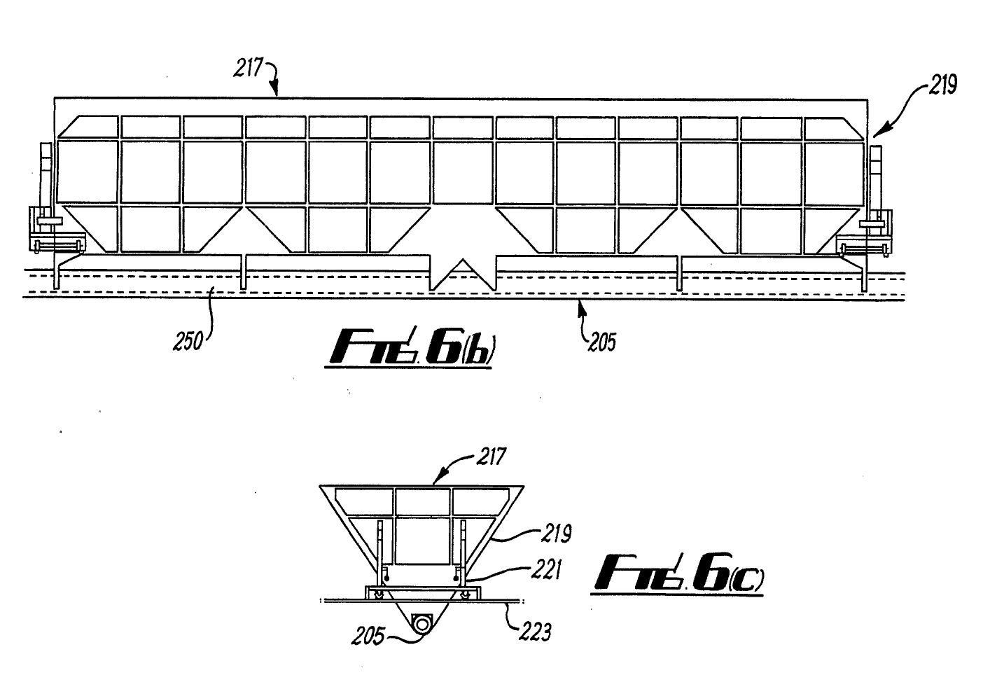

The frame 203 comprises a plurality of supporting sections 227 (illustrated in detail in FIGS. 5 (a) to (c)) which are securely fixed to the ground and are provided at appropriate intervals along the length of the rods to prevent buckling of the rods when in an expanded state.

Referring to FIG. 4 (a), the piston arrangement comprises two connecting rods 231 and 231′ and two corresponding pistons 233 and 233′ which are, themselves, mounted within two corresponding hydraulic cylinders 235 and 235′. One end of each connecting rod is pivotally mounted to the free end of the central rod. These two connecting rods are also in the horizontal plane and are pivotally connected to end portions of the frame 237 and 237′ at a distance adjacent to the central rod. The opposing end of each connecting rod is, in turn, pivotally connected to each corresponding piston. The connecting rods are mounted such that, when the central rod is in its normal room temperature state, the pistons are in the first position 239 and when in an expanded state, the pistons are in the second position 241 which corresponds to the piston's maximum stroke limit.

The hydraulic cylinders are in fluid communication with a hydraulic motor (not shown) via fluid lines 243 and 243′ which are provided to allow the flow of fluid at high pressures regardless of which direction the pistons move. The hydraulic motor drives a generator (not shown) which is capable of generating electrical power.

In use, during daylight hours, solar radiation is focussed onto the central metal rod 205 by the Fresnel lens 217. The resulting increase in temperature of the rod causes it to expand which, in turn, forces the connecting rods 231 and 231′ to pivot about their respective fulcrums 237 and 237′. The connecting rods exert a force on the pistons 233 which move from the first position 239 to the second position 241 and pressurise the fluid. The pressurised fluid passes through the hydraulic motor (not shown) which drives the generator (not shown) to produce electrical power.

When in the heated, expanded state, water is injected into the central hollow core 250 of the rod 205 via the pipeline 215. The excess thermal energy of the central rod boils the water contained therein which turns to steam. The steam is driven out of the central rod 205 and into the two adjacent hollow rods 207 and 207′ via pipelines 225. At the same time, the Fresnel lens 217 is moved from the central rod 205 to an adjacent rod 207 and a second Fresnel lens (not shown) is disposed adjacent the other neighbouring rod 207′. The transfer of thermal energy from the central rod 205 to the water and the absence of solar radiation from the lens cause the rod 205 to rapidly cool and contract. This contraction forces the pistons 233 and 233′ to move from the second position 241 to the first position 239 which drives fluid in the hydraulic cylinders 235 and 235′ through the motor in the reverse direction. At this point, the polarity of the motor is reversed or double return valves are activated so that the motor can utilise the reverse flow of the fluid.

The introduction of steam into the adjacent rods and the presence of Frensel lenses, which focus solar radiation onto the rods, serve to heat them up. The rods are, thus, able to maintain the water in the gaseous state. When the central rod returns to its normal contracted state and it is desired to cause it to expand and drive the pistons once more, the steam and Fresenl lens can be returned to the central rod to assist its expansion. This process is repeated rapidly to drive the hydraulic motor and produce consistent electrical power. In this way, the excess thermal energy of the central rod can be recycled.

Alternatively, sea water is pumped through the central rod 205 when in its heated state. The resulting steam produced is devoid of salt and other impurities which are left behind in the hollow core 250 of the central rod 205. The steam is then cooled and condensed in the adjacent rods 207 and 207′ which are not subjected to solar radiation and the resulting purified water is siphoned off. The apparatus can, thus, serve as a desalination plant. Due to the build up of salt and other impurities in the rod, it is necessary to periodically drill out the hollow core when its performance becomes impaired to ensure proper operation of the apparatus. It is therefore necessary for the hollow rods to have removable pressure covers (not shown) at either end to permit the drill (not shown) to gain access to the hollow core 250.

Alternatively, if desired, the piston arrangement can be used to drive a pump instead of a motor. This allows the apparatus to be used for irrigation purposes in remote areas where electricity is not readily available. It is envisaged that this alternative arrangement could be used in deserts to provide clean water for plant and animal life.

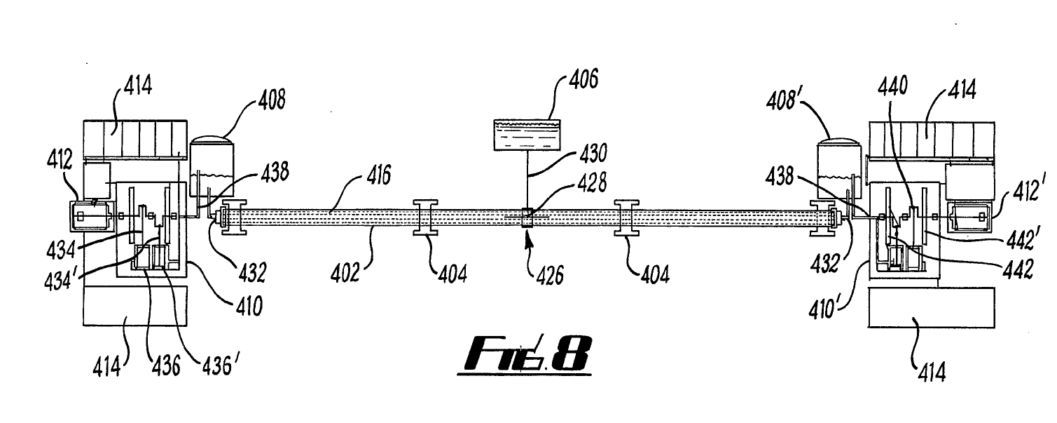

Referring to FIGS. 7 (a) to (c), it will be appreciated that the piston arrangement can be driven directly by the central rod without the need for connecting rods. In this alternative embodiment, there are provided five hydraulic cylinders 302 each with a corresponding piston 304. The pistons are connected to the central rod 306 by a spider 308 which serves to force the pistons a distance equal to the linear expansion of the central rod. Thus, the pistons 304 are driven directly by the central rod 306. The linear expansion of the rod is governed by the temperature change and original length of the rod. In this embodiment, fluid lines 308 run from either side of each hydraulic cylinder 302 and connect to form two single fluid lines 310 and 310′ which facilitate the flow of fluid in either direction and are in fluid communication with the hydraulic motor. Preferably the rod should be as long as possible and as much solar radiation from the Fresnel lens as possible should be focussed onto the rod to ensure a substantial linear expansion relative to the rod's original length.

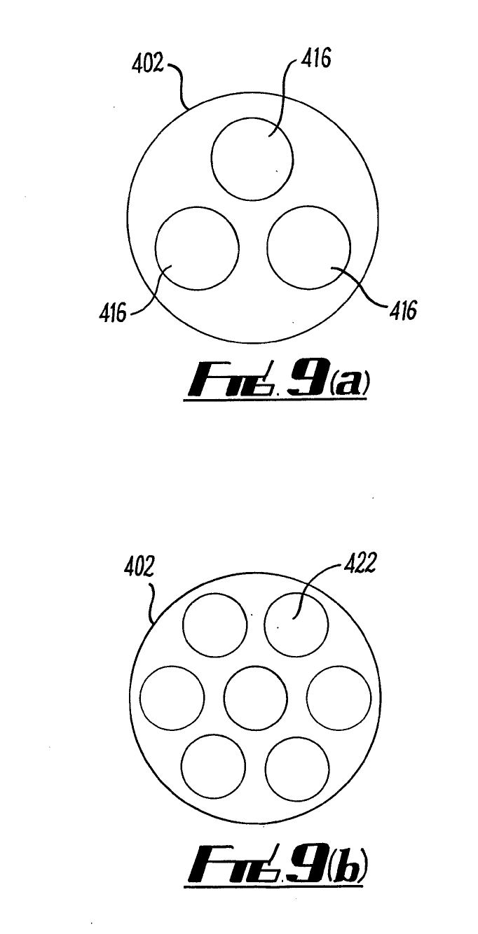

FIG. 8 illustrates an alternative embodiment which comprises a rod 402, a water source 406, a pair of steam accumulators 408, 408′, a pair of steam engine rooms 410, 410′, a corresponding motor 412, 412′ and a plurality of condensing areas 414.

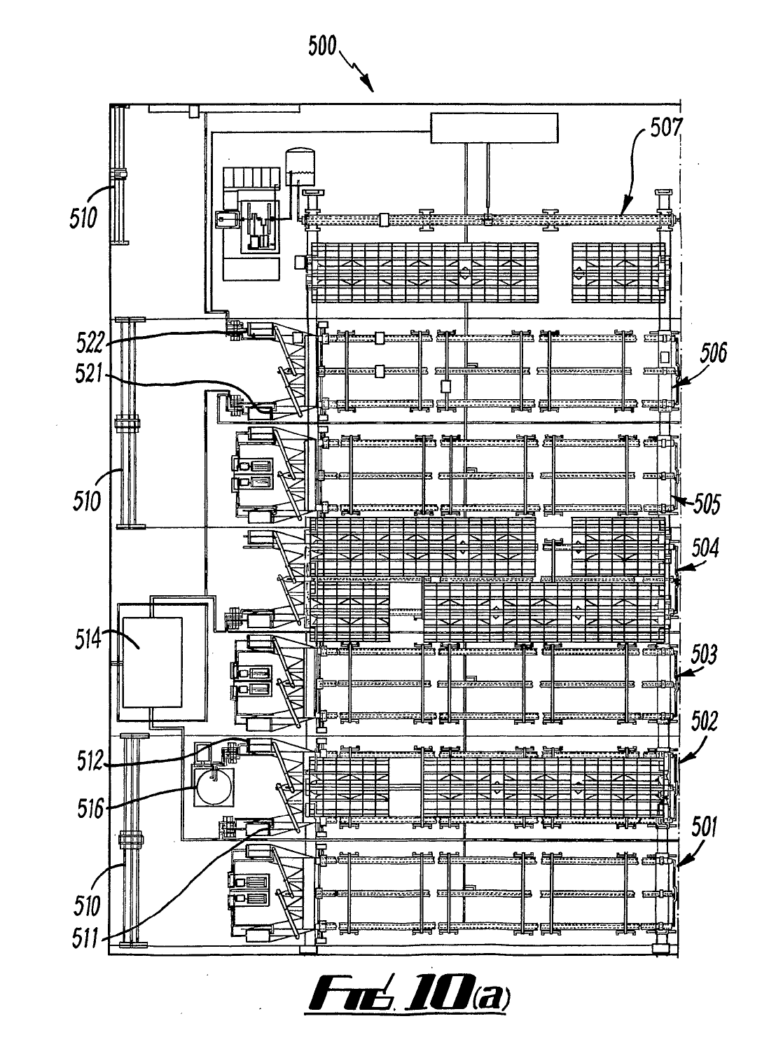

The rod 402 (depicted in FIG. 9 (a)) comprises a conductive material such as metal and has three hollow cores 416 which run longitudinally down the rod 402 and are spaced at 120 degrees from one another. It is, however, to be appreciated that more than three cores can be provided as depicted in FIG. 9 (b) which shows seven hollow cores 422.

Referring again to FIG. 8, the rod 402 is supported by a plurality of supports 404 which maintain the rod in the horizontal plane. The supports are firmly attached to the ground and are provided at intervals along the length of the rod to prevent it from buckling when subjected to solar radiation. The supports permit the rod to be rotated about its central longitudinal axis. This rotation is imparted to the rod by rotation means (not shown) which are disposed at either end of the rod.

A Fresnel lens (not shown) is mounted to the rod using a mounting frame according to the mounting apparatus described hereinbefore. The Fresnel lens is mounted such that its focal line is on the rod.

At the midpoint 426 of the rod 402 each hollow core has an injection hole 428 which permits the injection of water into the hollow cores. The water source 406 is connected to the midpoint of the rod by a pipeline 430. The injection holes of each corresponding hollow core are placed in fluid communication with the water source by rotating the rod such that an injection hole becomes aligned with the pipeline. Each hollow core is connected to the steam accumulators 408 and 408′ by high pressure connections 432 at each end of the rod 402.

Each steam accumulator 408, 408′ comprises a high pressure container which is connected to a corresponding steam engine room 410, 410′. Each steam engine room comprises a pair of pistons 434, 434′ which have associated hydraulic cylinders 436, 436′. The hydraulic cylinders contained therein are connected to their corresponding steam accumulators by high pressure pipelines 438. Each pipeline splits into two with one branch connected to one end of the hydraulic cylinder and the other branch connected to the opposing end of the cylinder. Thus, the piston will be driven by steam in either direction depending on which branch of pipeline the steam is channelled through. The steam engine room is sealed so that any surplus steam will condense and run into water collection units 414.

The pistons are connected to a crankshaft 440 which translates the reciprocating linear piston motion into rotation. Attached to the crankshaft is a pair of flywheels 442, 442′ which serve to reduce the pulsation characteristic of the piston's motion. The crankshaft is connected to a motor 412, 412′ which is itself connected to a generator (not shown) for the generation of electrical power.

The option exists for excess steam to be driven back through the pipelines by the pistons and into the hollow cores via the steam accumulators. This excess steam can thus be used to reheat the rod to facilitate the production of more steam which can be used to drive the pistons once more. Thus, excess thermal energy may be constantly recycled.

Alternatively the excess steam can be driven into the condensing areas 414 by the pistons 436, 436′ where the steam cools and condenses. It is therefore necessary to provide valves (not shown) within the high pressure steam pipelines 438 to direct the steam along the desired path.

In use, the rod is rotated such that a hollow core injection hole 428 is aligned with the water source pipeline 430. The Fresnel lens, depicted in FIG. 6 (a), focuses solar radiation onto the rod 402 which results in heating of the rod to well in excess of 100 degrees Celsius. The Fresnel lens is positioned such that the solar radiation is focussed onto the region of the rod that comprises the previously aligned hollow core. Water is then injected into the hollow core and is channelled down either side of the length of the heated rod where it is converted into steam.

The steam is channelled into the steam accumulators 408, 408′ at either end of the rod via the high pressure connections 432. Steam is then driven from the steam accumulators into the hydraulic cylinders 436, 436′ of the steam engine rooms 410, 410′. In each steam engine room, steam is directed by valves into opposing ends of each hydraulic cylinder to ensure that both pistons 434, 434′ are driven by the steam. The linear motion of the pistons is converted into rotation by the crankshafts 440, 440′ which in turn drives the motors 412, 412′. The motors are thus able to drive their associated generators (not shown) to produce electrical power.

If the apparatus is used as a desalination plant, in addition to an electrical power generator, sea water is pumped into the hollow core 416 and is converted into steam. The steam is devoid of salt and other impurities which are deposited in the hollow core. This purified water, in the form of gas, is channelled into the hydraulic cylinders which in turn drives the pistons and the motor. Excess steam is then cooled and condensed in the condensing areas 414 to provide purified, liquid water.

Since the hollow core 416 contains salt and other impurities, the rod is rotated such that a fresh hollow core is aligned with the water injection pipeline in order that the salt containing core can be cleaned by a drill (not shown) which is forced down the hollow core. Any impurities can then be transported away in wagons. At the same time, water is injected into the fresh core for the production of more steam which can be used to drive the motor. Thus, the hollow cores can be cleaned with no break in the production of steam so that electrical power can be constantly produced.

It is envisaged that the whole process may be fully automated and controlled by computers so that very little maintenance or workforce is necessary.

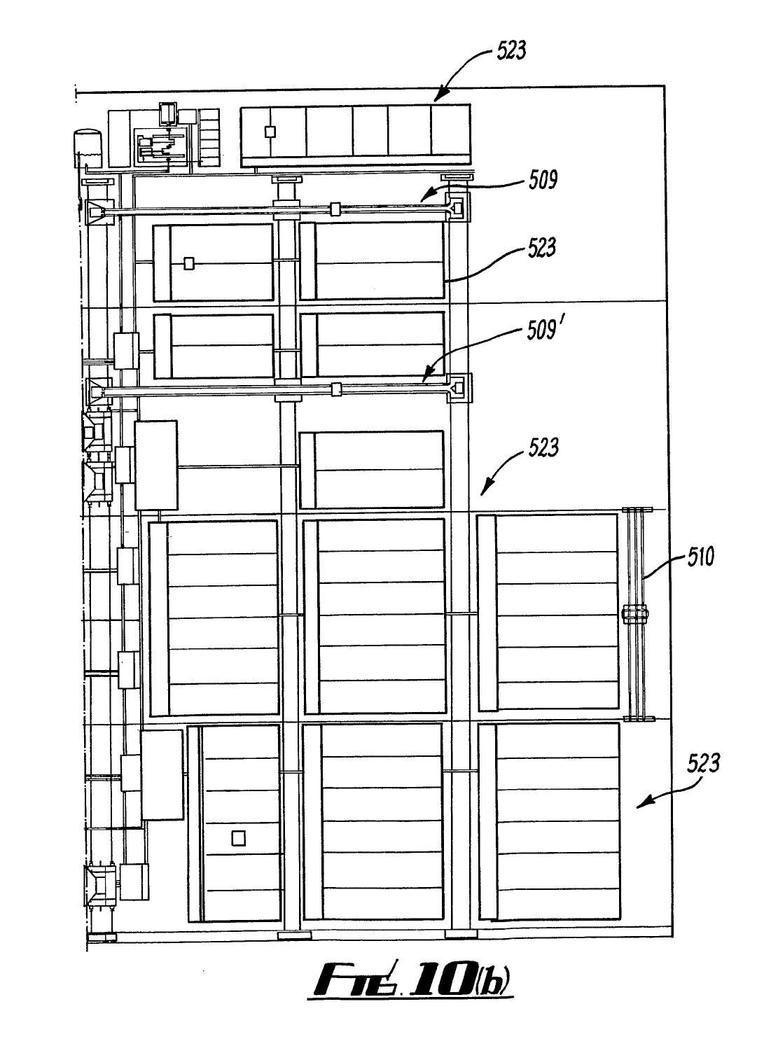

FIGS. 10 (a) and (b), taken together, show schematically how the apparatus according to the present invention can be incorporated into a power station 500. Six separate apparatus 501 to 506 corresponding to those apparatus depicted in FIGS. 4 (a) and (b) and described hereinbefore are placed adjacent and parallel to one another and are connected by high pressure pipelines. Four Fresnel lenses and corresponding mounting frames are provided which can be mounted to four separate rods as desired. The frames can be moved vertically off the rods and adjacent to the rods using rails so that other rods can be subjected to focussed solar radiation.

An apparatus 507 according to the present invention as illustrated in FIG. 8 and described hereinbefore is disposed adjacent to the six other apparatus. The rod of this embodiment has a diameter greater than that of the rods of the other six apparatus. A plurality of condensing areas 523 are located around the power station site and are connected by high pressure pipelines to each respective apparatus.

Two drilling rods 509, 509′ are disposed relative to the ends of the rods of the apparatus. One drilling rod has a diameter which corresponds to that of the inner diameter of the rods of the six apparatus and the other drilling rod has a diameter equivalent to that of the inner diameter of the rod of apparatus 507. The drilling rods are transportable by rail tracks such that each drilling rod can be aligned with the end of a separate apparatus rod.

The site is serviced by four overhead cranes 510 which are operative to transport elements of the power station. Thus, elements of the station that require replacing or servicing can be easily removed from the site.

A water tower 514 standing ten metres high for gravitational distribution of irrigation water is provided and is connected to piston 511 of apparatus 502 and piston 521 of apparatus 506. Piston 512 of apparatus 502 is connected to a steam accumulator 516 which can be used to drive piston 511 in the absence of solar radiation. Piston 522 of apparatus 506 is connected to a separate water collection unit and is used to pump supply water from an ocean, river or other water source into the collection unit.

Apparatus 501, 503 and 505 are used for electrical generation whilst apparatus 504 is reserved in case of malfunction of an operative apparatus.

In use, at the start of the day, a Fresnel lens is positioned over the rod of apparatus 507 and is used to focus solar radiation onto the rod. The rod is then heated until it reaches a temperature of 120 degrees Celcius at which point water is injected into the rod. This water is turned into steam which can be used to drive the steam engines disposed at either end of the rod. The steam engines drive generators which generate electrical power. This initial electrical power is used to start the rest of the station.

Using the electrical power generated by apparatus 507, Fresnel lenses are positioned over the two rods disposed either side of the central driving rod of apparatus 502 and 505. When the two neighbouring rods are heated to in excess of 100 degrees Celcius, the Fresnel lenses are positioned over the central driving rods which are caused to heat and expand and drive their respective pistons. When all rods are heated to boiling point, water is injected into their hollow cores which cause the water to turn to steam. This steam is then directed into the rods of the adjacent apparatus which causes those apparatus to activate and drive their respective pistons. In heating the rods of the apparatus, the water cools and condenses and returns to the liquid state. At this point, the water is directed into the heated rods of an adjacent apparatus which causes the rods to contract and the steam to return to the liquid state. In this way, the entire power station can be operated continuously by generating steam and using that steam, in combination with the Fresnel lenses, to heat adjacent pipes. The excess thermal energy of the station is thus recycled at every stage.

Any surplus steam produced by the plant is directed into the condensing areas 523 where it cools and condenses to form purified water. The water tower 514, which is constantly supplied by apparatus 502 and 505, uses gravity to distribute irrigation water around the surrounding land. At regular intervals, the rods of each apparatus are cleaned using drilling rods 509, 509′ to remove impurities deposited by the salt water when turned to steam.

It is therefore possible to produce an autonomous power station which can produce electrical power from solar radiation. In addition, the power station can be used to irrigate the surrounding landscape as well as for the desalination of salt water.

The above embodiments are described by way of example only. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. Apparatus for the utilization of thermal radiation, the apparatus comprising a thermosensitive member, a Fresnel lens for selectively directing thermal radiation onto the thermosensitive member, and a generator means for converting the resulting expansion and contraction of the thermosensitive member into electrical power.

2. Apparatus as claimed in claim 1, wherein the thermosensitive member is generally elongate.

3. Apparatus as claimed in claim 2, wherein the thermosensitive member is a rod.

4. Apparatus as claimed in claim 1, wherein the thermosensitive member is mounted to a frame.

5. Apparatus as claimed in claim 4, wherein one end of the thermosensitive member is fixed at one side of the frame and is free at the opposite side of the frame.

6. Apparatus as claimed in claim 5, wherein the free end of the thermosensitive member extends through the frame.

7. Apparatus as claimed in claim 5, wherein the free end of the thermosensitive member is connected to a piston.

8. Apparatus as claimed in claim 7, wherein the piston is seated within a hydraulic cylinder which is connected to a hydraulic motor.

9. Apparatus as claimed in claim 7, wherein the piston moves from a first position in which the thermosensitive member is in its normal, ambient temperature state, to a second position in which the thermosensitive member is in an expanded state, said second position corresponding to the piston's maximum stroke limit.

10. Apparatus as claimed in claim 5, wherein the free end of the thermosensitive member is connected to a piston via a corresponding connecting rod.

11. Apparatus as claimed in claim 10, wherein said connecting rod is pivotally mounted at either end to the free end of the thermosensitive member and the piston respectively.

12. Apparatus as claimed in claim 10, wherein the connecting rod pivots about an associated fulcrum which is positioned at a distance adjacent to the rod.

13. Apparatus as claimed in claims 10, comprising a plurality of pistons and associated connecting rods.

14. Apparatus as claimed in claim 1, wherein the Fresnel lens is arranged adjacent to the thermosensitive member.

15. Apparatus as claimed in claim 1, wherein the Fresnel lens can move in an arc about the thermosensitive member.

16. Apparatus as claimed in claim 3, wherein the lens can track the sun throughout the day so that maximum thermal radiation from the sun is focussed onto the rod.

17. Apparatus as claimed in claim 1, wherein the thermosensitive member has a hollow core.

18. Apparatus as claimed in claim 17, wherein fluid can be channelled through the hollow core.

19. Apparatus as claimed in claim 1, wherein the thermosensitive member is sealed at either end by removable pressure covers.

20. Apparatus as claimed in claim 1, wherein the thermosensitive member comprises a plurality of hollow cores.

21. Apparatus as claimed in claim 20, wherein the hollow cores are spaced from one another through the thermosensitive member.

22. A method of producing electrical power comprising the steps of:
arranging a Fresnel lens relative to a thermosensitive member;
using the Fresnel lens to direct solar radiation onto said thermosensitive member to cause expansion thereof; and
using the expansion of said thermosensitive member to drive a generator means for the generation of electrical power.

23. The method of claim 22, comprising the additional step of using the contraction of the thermosensitive member to drive the generator.

24. A method of desalinating salt water comprising the steps of:
arranging a Fresnel lens relative to a hollow thermosensitive member;
using the Fresnel lens to direct solar radiation onto said hollow thermosensitive member to cause said thermosensitive member to heat up;
injecting water into said hollow thermosensitive member;
directing the resulting water vapour out of said thermosensitive member; and
cooling and condensing said water vapour.
